(19) United States
(12) Patent Application Publication
(10) Pub. No.: US 2026/0081824 A1
(43) Pub. Date: Mar. 19, 2026

(54) DATA TRANSMISSION METHOD AND APPARATUS, ELECTRONIC DEVICE, AND STORAGE MEDIUM

(71) Applicant: Lenovo (Beijing) Limited, Beijing (CN)

(72) Inventors: Long LI, Beijing (CN); Yong YU, Beijing (CN)

(21) Appl. No.: 19/401,866

(22) Filed: Nov. 26, 2025

Related U.S. Application Data
(63) Continuation of application No. PCT/CN2024/075163, filed on Feb. 1, 2024.

(30) Foreign Application Priority Data
May 31, 2023 (CN) 202310636190.5

(51) Int. Cl. H04L 41/0803; H04W 76/28

(52) U.S. Cl. CPC H04L 41/0803; H04W 76/28

(57) ABSTRACT

A data transmission method includes obtaining a first initial configuration parameter for a first network link for communicating with a user terminal, and determining a target configuration parameter for at least one target network link based at least on the first initial configuration parameter. The at least one target network link includes at least a second network link for communicating with the user terminal, and the second network link has a second initial configuration parameter different from the first initial configuration parameter. The method further includes performing configuration parameter reconfiguration for at least the second network link based on the target configuration parameter, to enable the user terminal to receive data sent by the network terminal based on aggregation of the first network link and the second network link.

### CROSS-REFERENCE TO RELATED APPLICATION

This application is a continuation of International Application No. PCT/CN2024/075163, filed on February 1, 2024, which claims priority to Chinese Patent Application No.: 202310636190.5, filed on May 31, 2023, the entire contents of both of which are incorporated herein by reference.

### TECHNICAL FIELD

The present disclosure generally relates to the field of communication technologies and, more particularly, to a data transmission method, a data transmission apparatus, an electronic device, and a storage medium.

### BACKGROUND

In the field of communications, especially mobile communications, many communication technologies have emerged to achieve higher communication speeds and a higher quality network experience. For example, network aggregation technology allows Wireless Fidelity (WiFi) and mobile data networks to work simultaneously for high-throughput scenarios, achieving high network speeds, stability, and low latency.

Further, fixed-mobile convergence is also a key feature of 5G networks. The 3rd generation partnership project (3GPP) SA1 working groups have descriptions and standards regarding terminals accessing 5G networks via wired access technologies in the Rel-15 and Rel-16 protocols related to mobile 5G. Therefore, multi-path (two-way, three-way, etc.) access networks, which aggregate 3GPP mobile access networks (GSM/WCDMA/LTE/NR, etc.) and non-3GPP access networks (WiFi networks, Bluetooth BT networks, WiMax, etc.), are currently and will continue to be a focus of attention in the communications field.

Currently, 3GPP mobile communication networks use discontinuous reception (DRX) technology to reduce power consumption of terminal devices. DRX refers to that since a bursty nature of communication data (that is, data transmission occurs in certain time periods and not in others), one terminal only activates a receiver during necessary time periods to receive downlink data, and shuts the receiver down during remaining time periods to conserve power.

In the network aggregation communication scenarios described above, 3GPP mobile access networks (2G/3G/4G/5G) typically configure DRX-related parameters, classifying them as interval-based data reception. Non-3GPP access networks such as Wi-Fi/BT currently lack DRX-related technology (or even if similar technologies exist, their parameter values differ from those of 3GPP mobile access networks), classifying them as real-time data reception. Since there are currently no modules or functions network sides or device sides to uniformly schedule and handle this situation, inconsistencies and confusion arise in processing logics of receiving modules on different links within a user equipment (UE) during downlink data aggregation (or uplink data distribution), leading to a loss of synchronization between the various receiving modules on the UE.

### SUMMARY

In accordance with the disclosure, there is provided a data transmission method including obtaining a first initial configuration parameter for a first network link for communicating with a user terminal, and determining a target configuration parameter for at least one target network link based at least on the first initial configuration parameter. The at least one target network link includes at least a second network link for communicating with the user terminal, and the second network link has a second initial configuration parameter different from the first initial configuration parameter. The method further includes performing configuration parameter reconfiguration for at least the second network link based on the target configuration parameter, to enable the user terminal to receive data sent by a network terminal based on aggregation of the first network link and the second network link.

Also in accordance with the disclosure, there is provided a network terminal including a processor, and a memory storing instructions that, when executed by the processor, cause the network terminal to obtain a first initial configuration parameter for a first network link for communicating with a user terminal, and determine a target configuration parameter for at least one target network link based at least on the first initial configuration parameter. The at least one target network link includes at least a second network link for communicating with the user terminal, and the second network link has a second initial configuration parameter different from the first initial configuration parameter. The instructions, when executed by the processor, further cause the network terminal to perform configuration parameter reconfiguration for at least the second network link based on the target configuration parameter, to enable the user terminal to receive data sent by the network terminal based on aggregation of the first network link and the second network link.

Also in accordance with the disclosure, there is provided a data transmission method including receiving a target configuration parameter for at least one target network link allocated by a network terminal. The target configuration parameter is determined based on a first initial configuration parameter for a first network link, the at least one target network link includes at least a second network link, and the second network link has a second initial configuration parameter different from the first initial configuration parameter. The method further includes reconfiguring at least the second network link based on the target configuration parameter, and receiving data sent by the network terminal based on aggregation of the first network link and the second network link.

### BRIEF DESCRIPTION OF THE DRAWINGS

To more clearly illustrate the technical solutions of the embodiments of the present disclosure, the drawings for use in the description of the embodiments will be briefly introduced below. The drawings described below are some embodiments of the present disclosure. For those of ordinary skill in the art, other drawings can be obtained according to these drawings without any creative work. Throughout the drawings, the same or similar reference numerals represent the same or similar elements. It should be understood that the drawings are schematic and that the originals and elements are not necessarily drawn to scale.

FIG. 1 is a flowchart of an exemplary data transmission method consistent with embodiments of the present disclosure.

FIG. 2 is a flowchart of another exemplary data transmission method consistent with embodiments of the present disclosure.

FIG. 3 is a flowchart of another exemplary data transmission method consistent with embodiments of the present disclosure.

FIG. 4 shows an exemplary data transmission method.

FIG. 5 is a schematic diagram showing another exemplary data transmission method consistent with embodiments of the present disclosure.

FIG. 6 is a schematic structural diagram of a data transmission apparatus consistent with embodiments of the present disclosure.

FIG. 7 is a schematic structural diagram of another data transmission apparatus consistent with embodiments of the present disclosure.

FIG. 8 is a schematic structural diagram of an electronic device consistent with embodiments of the present disclosure.

### DETAILED DESCRIPTION OF THE EMBODIMENTS

Various schemes and features of the present disclosure are described herein with reference to the accompanying drawings. The described embodiments are only some of embodiments of the present disclosure, but the present disclosure is not limited to these specific embodiments. Those skilled in the art can make various variations and modifications based on the concept of the present disclosure, and these variations and modifications shall fall within the scope of the present disclosure.

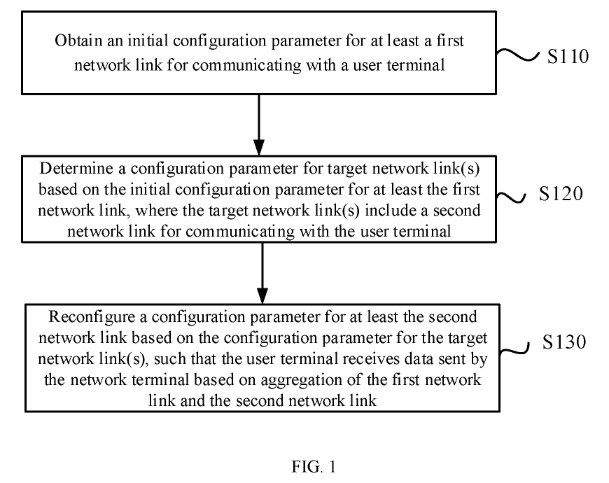

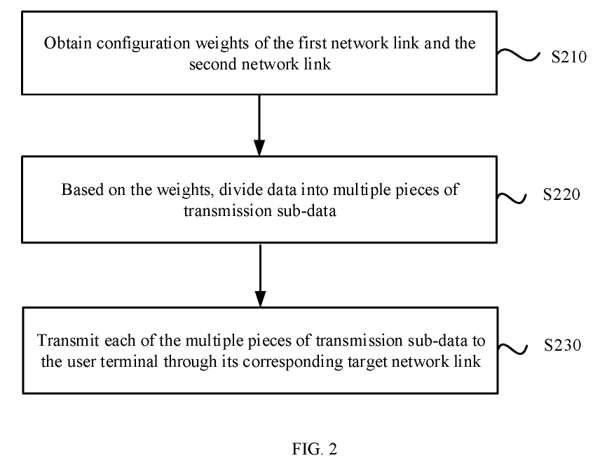

The present disclosure provides a data transmission method. FIG. 1 is a flowchart of a data transmission method provided by one embodiment of the present disclosure, applied to a network terminal. This method can be executed by a data transmission apparatus provided by the present disclosure, which may be implemented as software and/or hardware. As shown in FIG. 1, in this embodiment, the method includes S110 to S130.

At S110, an initial configuration parameter for at least a first network link for communication with a user terminal is obtained.

In this embodiment, the network terminal and the user terminal may communicate via at least the first network link. When the network terminal and the user terminal communicate, it may be needed to obtain the initial configuration parameter for at least the first network link to transmit corresponding data according to the initial configuration parameter. For example, when the initial configuration parameter for the first network link includes a discontinuous reception DRX parameter, such as the first network link being a 2G/3G/4G/5G 3GPP mobile access network, the network terminal may transmit corresponding data according to the configuration parameter for the DRX parameter. When the initial configuration parameter for the first network link does not include a discontinuous reception DRX parameter, such as the first network link being a non-3GPP access network like WIFI/BT, the network terminal may transmit real-time data.

In various embodiments, the network terminal may communicate with the user terminal solely through the first network link, or the network terminal may communicate with the user terminal simultaneously through both the first network link and a second network link. The present disclosure does not limit the number of network links.

In this embodiment, obtaining the initial configuration parameter for at least the first network link used for communication with the user terminal may include at least one of: obtaining the initial configuration parameter through uploading via the user terminal; obtaining the initial configuration parameter through uploading via an access network of the first network link and/or an access network of the second network link; or obtaining the initial configuration parameter through a parameter configuration library within the network terminal.

The parameter configuration library may record the initial configuration parameter for the first network link. The access network of the first network link and/or the access network of the second network link may be used to establish a network link pathway to achieve communication between the network terminal and the user terminal.

Since the network terminal and the user terminal communicate through at least the first network link, the initial configuration parameter for the first network link may be obtained in multiple ways. For example, when the parameter configuration library within the network terminal has pre-stored the initial configuration parameter for the first network link, the initial configuration parameter may be directly obtained from the parameter configuration library within the network terminal after receiving the request to obtain the initial configuration parameter for the first network link. As another example, after the user terminal and network terminal establish communication through the access network of the first network link, the initial configuration parameter for the first network link may be sent to the user terminal for storage. Therefore, the relevant initial configuration parameter may be uploaded through the user terminal. Alternatively, in another embodiment, the user terminal and network terminal may establish communication through the access network of the first network link and/or the second network link, the initial configuration parameter for the first network link may be obtained through the access network of the first network link and/or the second network link.

The initial configuration parameter for the first network link may be obtained through multiple methods, providing a foundation for the subsequent unified configuration of the configuration parameter for each network link.

At S120, a configuration parameter for target network link(s) is determined based on the initial configuration parameter for at least the first network link, where the target network link(s) include the second network link for communication with the user terminal. In this disclosure, the configuration parameter for the target network link(s) is also referred to as a “target configuration parameter.”

The target network link(s) may be part or all of links used for communication between the network terminal and the user terminal. The second network link and the first network link may be of the same or different types.

In this embodiment, when there are multiple network links between the network terminal and the user terminal, to avoid confusion and inconsistency in the downlink data aggregation (or uplink data distribution) processing logic of a receiving module of each link, the relevant parameter for each network link may need to be configured in a unified manner.

In this embodiment, when at least the first network link is included, only the initial configuration parameter for the first network link may be considered. For example, when the initial configuration parameter for the first network link is real-time data transmission, the configuration parameter for the target network link(s) may be determined according to a configuration method of real-time data transmission. When the initial configuration parameter for the first network link is the DRX parameter, the configuration parameter for the target network link(s) may be determined according to a configuration method of the DRX parameter. Further, the initial configuration parameter for the second network link may also be configured. For example, the configuration parameter for the target network link(s) may be determined by jointly using the DRX parameters of both the first network link and the second network link.

At S130, the configuration parameter for at least the second network link is reconfigured based on the configuration parameter for the target network link(s) (i.e., configuration parameter reconfiguration is performed for at least the second network link based on the configuration parameter for the target network link(s)),such that the user terminal receives data sent by the network terminal based on the aggregation of the first network link and the second network link.

The first network link may have a first initial configuration parameter, and the second network link may have a second initial configuration parameter. The first initial configuration parameter may be different from the second initial configuration parameter.

After determining the configuration parameter for the target network link(s), the configuration parameter for the second network link may be reconfigured using the configuration parameter for the target network link(s). In another embodiment, the configuration parameters of the first network link and the second network link may be reconfigured using the configuration parameter for the target network link(s). It should be noted that a flexible configuration may be realized according to the current number and types of the network links, without limiting the configuration method.

In this embodiment, obtaining the initial configuration parameter for at least the first network link for communication with the user terminal and determining the configuration parameter for the target network link(s) based on the initial configuration parameter for at least the first network link may include: acquiring the first initial configuration parameter for the first network link and the second initial configuration parameter for the second network link for communication with the user terminal; and determining the configuration parameter for the target network link(s) based on the first initial configuration parameter and the second initial configuration parameter. The first initial configuration parameter may be configured with a first discontinuous reception DRX parameter; the second initial configuration parameter may be configured with a second discontinuous reception DRX parameter, and the first discontinuous reception DRX parameter may be different from the second discontinuous reception DRX parameter.

The embodiment with two network links is used as an example to illustrate the present disclosure. Both network links may be configured with the DRX parameters, while the DRX parameters are different. That is, the first discontinuous reception DRX parameter may be different from the second discontinuous reception DRX parameter. The configuration parameter for the target network link(s) may be determined based on the first DRX parameter and the second DRX parameter jointly.

In one embodiment, determining the configuration parameter for the target network link(s) based on the first initial configuration parameter and the second initial configuration parameter may include: obtaining a first DRX parameter within the first initial configuration parameter and a second DRX parameter within the second initial configuration parameter; determining one DRX parameter with a longest sleep time as the configuration parameter for the target network link; or, determining a target DRX parameter based on the first DRX parameter, the second DRX parameter, and their corresponding weights, and using the target DRX parameter as the configuration parameter for the target network link; or, determining one DRX parameter with the highest priority among the first parameter and the second DRX parameter as the configuration parameter for the target network link(s).

For example, in one embodiment, the first DRX parameter obtained may be 10s sleep and 3s transmission, and the second DRX parameter may be 2s sleep and 4s transmission. When the DRX parameter with the longest sleep time is used as the configuration parameter for the target network link(s), the configuration parameter with 10s sleep and 3s transmission may be used as the configuration parameter for the target network link(s). As another example, when the first DRX parameter has a weight of 0.8 and the second DRX parameter has a weight of 0.2, the target DRX parameter may be redefined based on the weights as 8.4s sleep time and 3.8s transmission time, which is used as the configuration parameter for the target network link(s).

As another example, when the first DRX parameter and the second DRX parameter have priorities, the DRX parameter with the highest priority may also be used as the configuration parameter for the target network link(s). In the current network environment, the DRX configuration parameter corresponding to a network with the fastest download speed may be configured to have the highest priority and then may be used as the configuration parameter for the target network link(s). Or, in another embodiment, based on prior experience, the priority of the DRX parameter of each network may be configured and the configuration parameter with the highest priority may be used as the configuration parameter for the target network link(s). For example, when the priority of the first DRX parameter is 7 and the second DRX parameter is 3, the first DRX parameter may be used as the configuration parameter for the target network link(s).

This embodiment illustrates three ways to determine the configuration parameter for the target network link(s). In other embodiments, other methods may also be used to determine the configuration parameter for the target network link(s), and the specific implementation method is not limited in the present disclosure.

In one embodiment, the method may further include S210-S230.

At S210, weights configured for the first network link and the second network link are obtained.

In addition to setting weights for the DRX parameters, in one embodiment, the weights configured for the first network link and the second network link may be obtained before any of S110-S130. In one embodiment, for example, the configured weights may be obtained through the network terminal and/or the user terminal and/or the first network link (or the second network link).

At S220, data is divided into multiple pieces of transmission sub-data according to the weights.

In this embodiment, the data transmitted between the network terminal and the user terminal may be divided into multiple pieces of transmission sub-data according to the weights. For example, more data may be allocated to the network link with a higher weight for transmission.

At S230, the multiple pieces of transmission sub-data are transmitted to the user terminal through the corresponding target network link(s).

In this embodiment, the multiple pieces of transmission sub-data may be distributed to the user terminal according to the weights. For example, more data may be distributed to the network link with a higher weight and less data may be distributed to the network link with a lower weight.

In this embodiment, a user terminal scenario or instruction may also be acquired. When the user terminal scenario or instruction meets a target condition, at least the first network link and the second network link may be established as network links capable of communication at the current moment. Based on at least the first network link and the second network link, the data may be sent to the user terminal.

In one embodiment, the user terminal scenario may represent a specified scenario in which the user uses the network link. The target condition may be a condition under which the user meets a specified scenario for using the network link. For example, communication links of some special calls, emergency calls, or weak signal may be set as scenarios that meet the target conditions. A special call may be a phone number set by the user for an important person, such as a family member or leader. An emergency call may be, for example, a fire number, a police number, or an ambulance call.

To ensure the communication stability of important or emergency calls, all call links that the user terminal can establish at the current moment may be simultaneously established when it detects that the user manually or automatically triggers a voice call in the above-mentioned special scenario, as network links capable of communication at the current moment, such as at least the first network link and the second network link. Therefore, multiple networks may be aggregated to send voice data to the user terminal. When one network link becomes unstable during communication, the system may immediately switch to another network link to receive data.

In this embodiment, designed for specific scenarios or instructions, the multiple network links may be established simultaneously and multi-link aggregation may be used for data transmission, thus avoiding the problem of data transmission stability being affected by poor network communication signals.

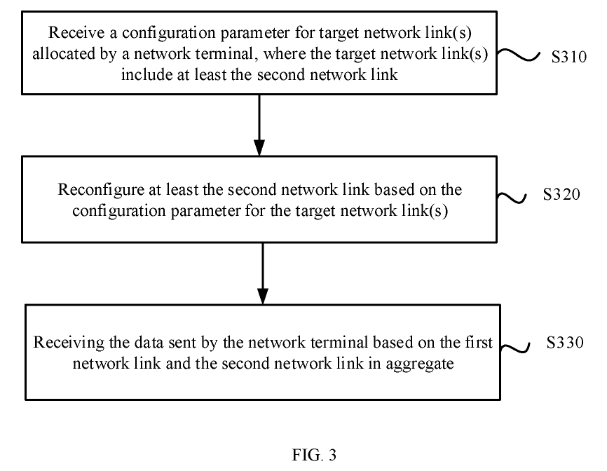

FIG. 3 is a flowchart of another data transmission method provided by the present disclosure, applied to a user terminal. The user terminal may receive data based on a first network link and a second network link. This method may be executed by a data transmission apparatus provided in this embodiment, which may be implemented in software and/or hardware. The method may include S310 to S330.

At S310, a configuration parameter for target network link(s) allocated by a network terminal is obtained, where the target network link(s) include at least a second network link.

The configuration parameter for the target network link(s) may be determined based on at least the initial configuration parameter for the first network link. The first network link may have the first initial configuration parameter, and the second network link may have the second initial configuration parameter. The first initial configuration parameters may be different from the second initial configuration parameter.

The method in this embodiment may be applied to the user terminal and may receive the configuration parameter for the target network link(s) sent by the network terminal. The target network link(s) may include only the second network link, or it may include both the first network link and the second network link simultaneously.

At S320, at least the second network link is reconfigured based on the configuration parameter for the target network link(s).

In this embodiment, the parameter of the first network link may be kept unchanged, and the second network link may be reconfigured as the target network link; or both the first network link and the second network link may be reconfigured as target network link(s) simultaneously.

For example, when the target network link(s) only include the second network link, it may only need to reconfigure the parameter of the second network link according to the configuration parameter for the target network link(s). When the target network link(s) include both the first network link and the second network link, the parameters of the first network link and the second network link may be reconfigured according to the configuration parameter for the target network link(s), such that the parameters of the first network link and the second network link may be uniformly scheduled.

At S330, data sent by the network terminal is received based on the aggregation of the first network link and the second network link.

In this embodiment, after reconfiguring at least the second network link, the data sent by the network terminal may be received through the aggregation of the first network link and the second network link. When the data is divided into transmission sub-data which is transmitted to the user terminal, the user terminal may receive the multiple pieces of transmission sub-data sent by multiple network links, and then aggregate the multiple pieces of transmission sub-data into the data.

In one embodiment of the present disclosure, determining the configuration parameter for the target network link(s) based on at least the initial configuration parameter for the first network link, may include: obtaining the first initial configuration parameter for the first network link and the second initial configuration parameter for the second network link through the network terminal, and determining the configuration parameter for the target network link(s) based on the first initial configuration parameter and the second initial configuration parameter. The first initial configuration parameter may be configured with a first discontinuous reception DRX parameter; the second initial configuration parameter may be configured with a second discontinuous reception DRX parameter, and the first discontinuous reception DRX parameter may be different from the second discontinuous reception DRX parameter.

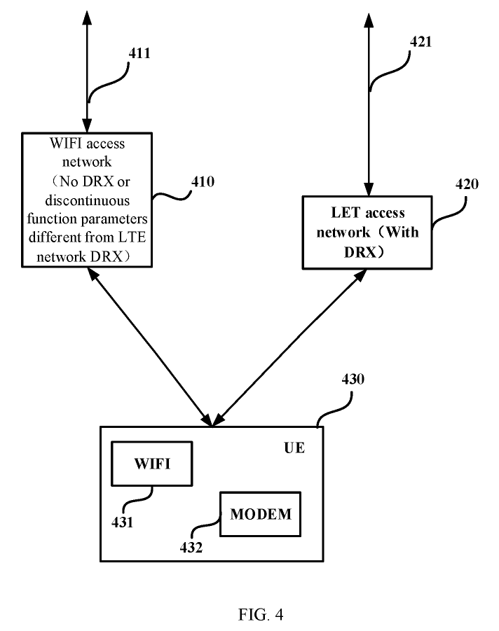

FIG. 4 is a schematic diagram showing a data transmission method, applied to a user terminal and a network terminal. As shown in FIG. 4, the data transmission includes: a WIFI access network 410, a first network link 411 (hereinafter referred to as Link 1), an LTE access network 420, a second network link 421 (hereinafter referred to as Link 2), a user terminal 430, a WIFI module 431 within the user terminal, and a communication module 432 (MODEM) within the user terminal. FIG. 4 illustrates this using the WIFI access network and the LTE access network as examples of the first network link and the second network link, respectively.

In existing technologies, when data is distributed from the data network in the background of the network terminal (not shown in FIG. 4), the data is sent to the user terminal UE 430 by the WIFI access network 410 of Link 1 and the LTE access network 420 of Link 2 after being split. However, at this time, the MODEM module 432 in the UE’s communication chip may be in a dormant state according to its DRX-related configuration, and the UE 430 may not receive the data sent through the LTE access network 420 of Link 2. However, since the Wi-Fi module 431 in UE430 lacks DRX-related technology, it is constantly monitoring Link 1 and can receive data from Link 1 at any time. This causes inconsistency in the UE430’s behavior when simultaneously receiving data from Link 1 and Link 2.

If UE430 adopts a solution that ignores DRX-related technology on Link 2, it would need to constantly monitor the relevant communication channels on both Link 1 and Link 2, inevitably leading to a sharp increase in UE430 power consumption. Alternatively, UE430 could temporarily withhold downlink data from Wi-Fi module 431 and Link 1, waiting for MODEM module 432 and Link 2 to wake up before aggregating and receiving data together. However, this approach has two problems. First, if Link 1 lacks DRX technology, the overall power consumption of UE430 will be very high. Second, since Link 1 and Wi-Fi module 431 need to wait for Link 2 and MODEM module 432 to wake up before transmitting together, it will inevitably increase the data transmission latency of the user terminal and reduce the user’s quality of service (QoS). Therefore, existing technologies suffer from problems such as chaotic and inconsistent processing logic among the receiving modules of each link in the UE during downlink data aggregation (or uplink data distribution), leading to a loss of synchronization between the receiving modules at the UE end.

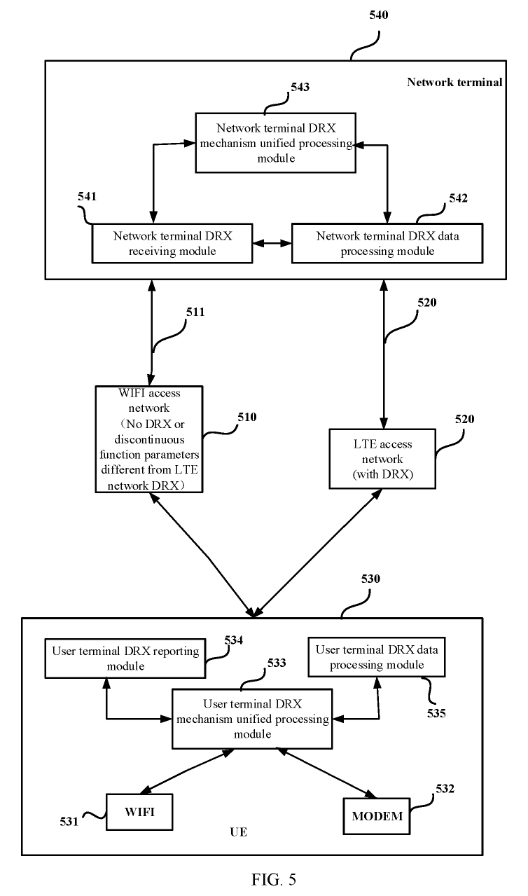

FIG. 5 is a schematic diagram showing an exemplary data transmission method provided by an embodiment of the present disclosure, applied to a user terminal and a network terminal. As shown in FIG. 5, the data transmission includes: a WIFI access network 510, a first network link 511 (referred to as Link 1), an LTE access network 520, a second network link 521 (referred to as Link 2); a user terminal 530 including a WIFI module 531 and a communication module 532 (MODEM) within the user terminal, a user terminal DRX mechanism unified processing module 533, a user terminal DRX reporting module 534, a user terminal DRX data processing module 535, a network terminal 540, a network terminal DRX mechanism unified processing module 543, a network terminal DRX receiving module 541, and a network terminal DRX data processing module 542.

FIG. 5 also uses the WIFI access network and LTE access network as the access networks for the first network link and the second network link, respectively, as examples for illustration. This embodiment adds the following functional modules or logical processing flows to the user terminal and/or network terminal. The specific interaction flow may include:

1) the user terminal DRX reporting module 534 is used to report the DRX-related parameters issued by the 3GPP radio access link to the network terminal DRX receiving module 541 within the network terminal 540, that is, to upload the first initial configuration parameter for the first network link to the network terminal;

2) the network terminal DRX receiving module 541 is used to receive the DRX-related parameters reported by the user terminal 534;

3) the network terminal DRX mechanism unified processing module 543 is used to perform unified planning and logical processing of the DRX situation on each link of the network terminal 540, that is, to determine the configuration parameter for the target network link;

4) the network terminal DRX data processing module 542 is used to perform data splitting and aggregation operations on downlink distributed data and uplink uploaded data under the DRX mechanism;

5) the user terminal DRX data processing module 530 is used to receive the configuration parameter for the target network link(s) sent by the network terminal 540 and process the distribution data issued by the network terminal 540;

6) the user terminal DRX mechanism unified processing module 533 is used to reallocate the DRX corresponding to each link (i.e., the WIFI module 531 and the MODEM module 532) in the user terminal 530 according to the configuration parameter for the target network link(s).

It should be noted that the user terminal DRX reporting module 534 in this embodiment is only one way to report the first initial configuration parameter for the first network link. In other embodiments, the initial configuration parameters of each network link may be obtained through other methods. Further, the first initial configuration parameter for the first network link (WIFI access network) 510 in this embodiment may be different from the second initial configuration parameter for the second network link 520, or no initial configuration parameters may be configured.

Under the DRX mechanism, this embodiment may both ensure the scheduling and synchronization of communication resources among aggregated links (3GPP wireless communication links + non-3GPP communication links), reduce data transmission latency in the user plane, and reduce power consumption at the device end.

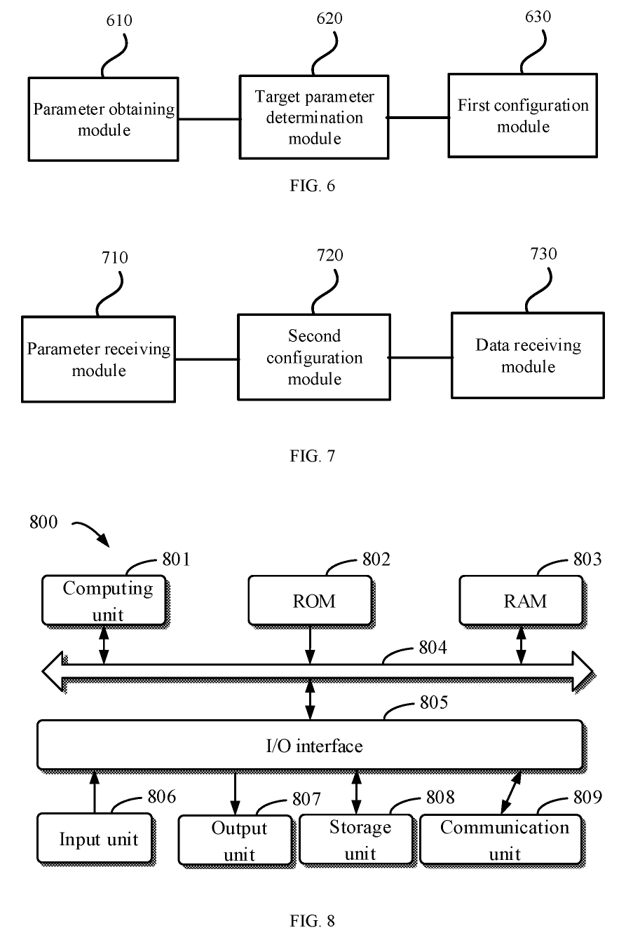

The present disclosure also provides a data transmission apparatus. In one embodiment shown in FIG. 6, which is a schematic diagram of a data transmission apparatus according to the present disclosure, the device may include: a parameter obtaining module 610 configured to acquire an initial configuration parameter for at least a first network link for communication with a user terminal; a target parameter determination module 620 configured to determine a configuration parameter for target network link(s) based on the initial configuration parameter for at least the first network link, where the target network link(s) include a second network link for communication with the user terminal; and a first configuration module 630 configured to reconfigure the configuration parameter for at least the second network link based on the configuration parameter for the target network link(s), such that the user terminal receives data sent by the network terminal based on the aggregation of the first network link and the second network link.

The first network link may have the first initial configuration parameter, and the second network link may have the second initial configuration parameter, where the first initial configuration parameter is different from the second initial configuration parameter.

In one embodiment, the target parameter determination module 620 may be configured to: acquire the first initial configuration parameter for the first network link for communication with the user terminal and the second initial configuration parameter for the second network link; and determine the configuration parameter for the target network link(s) based on the first initial configuration parameter and the second initial configuration parameter. The first initial configuration parameter may be configured with a first discontinuous reception DRX parameter and the second initial configuration parameter may be configured with a second discontinuous reception DRX parameter, where the first discontinuous reception DRX parameter is different from the second discontinuous reception DRX parameter.

In one embodiment, the parameter obtaining module 610 may be configured to perform at least one of: acquiring the initial configuration parameter by uploading via the user terminal; or acquiring the initial configuration parameter by uploading via the access network of the first network link and/or the access network of the second network link; or acquiring the initial configuration parameter via a parameter configuration library within the network terminal.

In one embodiment, the target parameter determination module 620 may be configured to: acquire the first DRX parameter within the first initial configuration parameter and the second DRX parameter within the second initial configuration parameter; and, determine the DRX parameter with a longest sleep time as the configuration parameter for the target network link(s), or determine a target DRX parameter based on the first DRX parameter and the second DRX parameter and their corresponding weights and use the target DRX parameter as the configuration parameter for the target network link(s), or, determine the DRX parameter with a highest priority among the first DRX parameter and the second DRX parameter as the configuration parameter for the target network link(s).

In one embodiment, the device may further include: a transmission module, configured to acquire the configuration weights of the first network link and the second network link; divide the data into multiple pieces of transmission sub-data according to the weights; and send the multiple pieces of transmission sub-data to the user terminal through the corresponding target network link(s).

In one embodiment, the transmission module may be further configured to: acquire a user terminal scenario or instruction; when the user terminal scenario or instruction meets a target condition, establish at least the first network link and the second network link as network links capable of communication at the current moment; and send the data to the user terminal based on the at least the first network link and the second network link.

In another embodiment, as shown in FIG. 7, which is a schematic diagram of another data transmission apparatus according to the present disclosure, applied to a user terminal capable of receiving data based on a first network link and a second network link, the device includes:

a parameter receiving module 710, configured to receive a configuration parameter for target network link(s) allocated by a network terminal, where: the target network link(s) may include at least a second network link, and the configuration parameter for the target network link(s) may be determined based on the initial configuration parameter for at least the first network link, the first network link may have a first initial configuration parameter, the second network link may have a second initial configuration parameter, and the first initial configuration parameter may be different from the second initial configuration parameter;

a second configuration module 720, configured to reconfigure at least the second network link based on the configuration parameter for the target network link;

a data receiving module 730, configured to receive data sent by the network terminal by aggregation based on the first network link and the second network link.

In one embodiment, the parameter receiving module 710 may be configured to: acquire a first initial configuration parameter for a first network link and a second initial configuration parameter for a second network link through a network terminal; and determine the configuration parameter for the target network link(s) based on the first initial configuration parameter and the second initial configuration parameter, where the first initial configuration parameter may be configured with a first discontinuous reception DRX parameter and the second initial configuration parameters may be configured with a second discontinuous reception DRX parameter with the first discontinuous reception DRX parameter being different from the second discontinuous reception DRX parameter.

The present disclosure also provides an electronic device and a readable storage medium.

In one embodiment, as shown in FIG. 8, which is a schematic block diagram of an exemplary electronic device 800 that may be used to implement embodiments of the present disclosure, the electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processors, cellular phones, smartphones, wearable devices, and other similar computing devices. The components shown herein, their connections and relationships, and their functions are merely examples and are not intended to limit the implementation of the disclosure described and/or claimed herein.

As shown in FIG. 8, the electronic device 800 includes a computing unit 801 configured to perform various appropriate actions and processes based on a computer program stored in a read-only memory (ROM) 802 or a computer program loaded from a storage unit 808 into a random access memory (RAM) 803. RAM 803 may also store various programs and data required for the operation of the electronic device 800. The computing unit 801, ROM 802, and RAM 803 are interconnected via a bus 804. An input/output (I/O) interface 805 is also connected to bus 804.

Multiple components in the electronic device 800 may be connected to the I/O interface 805, including, an input unit 806, such as a keyboard, a mouse, etc.; an output unit 807, such as various types of displays, speakers, etc.; a storage unit 808, such as disks, optical disks, etc.; and a communication unit 809, such as network interface cards, modems, wireless transceivers, etc. The communication unit 809 may allow the electronic device 800 to exchange information/data with other devices through computer networks such as the Internet and/or various telecommunications networks.

The computing unit 801 may be a variety of general-purpose and/or special-purpose processing components with processing and computing capabilities. Some examples of the computing unit 801 include, but are not limited to, a central processing unit (CPU), a graphics processing unit (GPU), various special-purpose artificial intelligence (AI) computing chips, various computing units running machine learning model algorithms, a digital signal processor (DSP), or any suitable processor, controller, microcontroller, etc. The computing unit 801 may be configured to perform the various methods or processes described above, such as the data transmission methods. For example, in some embodiments, the data transmission method may be implemented as a computer software program tangibly stored in a machine-readable medium, such as the storage unit 808. In some embodiments, part or all of the computer program may be loaded and/or installed on the electronic device 800 via ROM 802 and/or the communication unit 809. When the computer program is loaded into RAM 803 and executed by the computing unit 801, one or more steps of the data transmission method described above may be performed. Alternatively, in other embodiments, the computing unit 801 may be configured to perform the data transmission method by any other suitable means (e.g., by means of firmware).

Various embodiments of the systems and techniques described above herein can be implemented in digital electronic circuit systems, integrated circuit systems, field-programmable gate arrays (FPGAs), application-specific integrated circuits (ASICs), application-specific standard products (ASSPs), system-on-a-chip (SoCs), complex programmable logic devices (CPLDs), computer hardware, firmware, software, and/or any combinations thereof. These various embodiments may include implementations in one or more computer programs that can be executed and/or interpreted on a programmable system including at least one programmable processor, which may be a dedicated or general-purpose programmable processor, capable of receiving data and instructions from a storage system, at least one input device, and at least one output device, and transferring data and instructions to the storage system, the at least one input device, and the at least one output device.

Program codes for implementing the methods of the present disclosure can be written in any combination of one or more programming languages. The program codes can be provided to a processor or a controller of a general-purpose computer, a dedicated computer, or other programmable data processing apparatus such that, when executed by the processor or controller, the program codes cause the functions/operations specified in the flowcharts and/or block diagrams to be implemented. The program codes may be executed entirely on a machine, partially on a machine, or as a standalone software package, partially on a machine and partially on a remote machine, or entirely on a remote machine or server.

In the context of the present disclosure, a machine-readable medium can be a tangible medium that may contain or store a program for use by or in conjunction with an instruction execution system, apparatus, or device. The machine-readable medium can be a machine-readable signal medium or a machine-readable storage medium. Machine-readable media may be, but are not limited to, electronic, magnetic, optical, electromagnetic, infrared, or semiconductor systems, apparatus, or devices, or any suitable combination thereof. More specific examples of machine-readable storage media include electrical connections based on one or more wires, portable computer disks, hard disks, random access memory (RAM), read-only memory (ROM), erasable programmable read-only memory (EPROM or flash memory), optical fiber, portable compact disk read-only memory (CD-ROM), optical storage devices, magnetic storage devices, or any suitable combination thereof.

To provide interaction with a user, the systems and techniques described herein can be implemented on a computer including: a display device for displaying information to the user (e.g., a CRT (cathode ray tube) or LCD (liquid crystal display) monitor); and a keyboard or pointing device (e.g., a mouse or a trackball) through which the user provides input to the computer. Other types of devices may also be used to provide interaction with the user. For example, feedback provided to the user can be any form of sensory feedback (e.g., visual feedback, auditory feedback, or tactile feedback); and input from the user can be received in any form (including sound input, voice input, or tactile input).

The systems and techniques described herein can be implemented in computing systems that include back-end components (e.g., as a data server), or computing systems that include middleware components (e.g., an application server), or computing systems that include front-end components (e.g., a user computer with a graphical user interface or web browser through which the user interacts with embodiments of the systems and techniques described herein), or computing systems that include any combination of such back-end components, middleware components, or front-end components. System components can be interconnected via digital data communication (e.g., communication networks) of any form or medium. Examples of communication networks include Local Area Networks (LANs), Wide Area Networks (WANs), and the Internet.

Computer systems can include clients and servers. Clients and servers may be generally and geographically separated and typically interact via communication networks. Client-server relationships may be created by computer programs running on respective computers and having a client-server relationship with each other. Servers may be cloud servers, distributed system servers, or servers incorporating blockchain technology.

It should be understood that steps can be rearranged, added, or deleted using the various forms of processes shown above. For example, the steps described in the present disclosure can be performed in parallel, sequentially, or in different orders, as long as the desired results of the technical solutions disclosed in the present disclosure are achieved, which is not limited herein.

Further, the terms “first” and “second” are used for descriptive purposes only and should not be construed as indicating or implying relative importance or implicitly specifying the number of indicated technical features. Thus, a feature defined with “first” or “second” may explicitly or implicitly include at least one of that feature. In the description of this disclosure, “multiple” and “plurality of” means two or more, unless otherwise expressly and specifically defined.

The above describes in detail a plurality of embodiments of the present disclosure, but the present disclosure is not limited to these specific embodiments. Those skilled in the art can make various variations and modifications based on the concept of the present disclosure, and these variations and modifications shall fall within the scope of the present disclosure.

What is claimed is:

1. A data transmission method comprising:
obtaining a first initial configuration parameter for a first network link for communicating with a user terminal;
determining a target configuration parameter for at least one target network link based at least on the first initial configuration parameter, the at least one target network link including at least a second network link for communicating with the user terminal, and the second network link having a second initial configuration parameter different from the first initial configuration parameter; and
performing configuration parameter reconfiguration for at least the second network link based on the target configuration parameter, to enable the user terminal to receive data sent by a network terminal based on aggregation of the first network link and the second network link.

2. The method according to claim 1, further comprising:
obtaining the second initial configuration parameter;
wherein:
determining the target configuration parameter includes determining the target configuration parameter based on the first initial configuration parameter and the second initial configuration parameter; and
the first initial configuration parameter is configured with a first discontinuous reception (DRX) parameter, the second initial configuration parameter is configured with a second DRX parameter different from the DRX parameter.

3. The method according to claim 2, wherein determining the target configuration parameter based on the first initial configuration parameter and the second initial configuration parameter includes:
obtaining the first DRX parameter within the first initial configuration parameter and the second DRX parameter within the second initial configuration parameter; and
determining one of the first DRX parameter and the second DRX parameter with a longer sleep time as the target configuration parameter.

4. The method according to claim 2, wherein determining the target configuration parameter based on the first initial configuration parameter and the second initial configuration parameter includes:
obtaining the first DRX parameter within the first initial configuration parameter and the second DRX parameter within the second initial configuration parameter; and
determining the target configuration parameter based on the first DRX parameter, the second DRX parameter, and weights corresponding to the first DRX parameter and the second DRX parameter, respectively.

5. The method according to claim 2, wherein determining the target configuration parameter based on the first initial configuration parameter and the second initial configuration parameter includes:
obtaining the first DRX parameter within the first initial configuration parameter and the second DRX parameter within the second initial configuration parameter; and
determining one of the first DRX parameter and the second DRX parameter with a higher priority as the target configuration parameter.

6. The method according to claim 1, wherein obtaining the first initial configuration parameter includes obtaining the first initial configuration parameter uploaded by the user terminal.

7. The method according to claim 1, wherein obtaining the first initial configuration parameter includes obtaining the first initial configuration parameter uploaded by an access network of the first network link and/or an access network of the second network link.

8. The method according to claim 1, wherein obtaining the first initial configuration parameter includes obtaining the first initial configuration parameter from a parameter configuration library in the network terminal.

9. The method according to claim 1, further comprising:
obtaining configuration weights of the first network link and the second network link;
based on the weights, dividing the data into a plurality of pieces of transmission sub-data; and
transmitting each of the plurality of pieces of transmission sub-data to the user terminal through a corresponding one of the at least one target network link.

10. The method according to claim 1, further comprising:
obtaining a user terminal scenario or instruction;
in response to the user terminal scenario or instruction meeting a target condition, establishing at least the first network link and the second network link; and
based on the at least the first network link and the second network link, sending the data to the user terminal.

11. A non-transitory machine-readable storage medium storing instructions that, when executed by a processor, cause a network terminal including the processor to perform the method according to claim 1.

12. A network terminal comprising:
a processor; and
a memory storing instructions that, when executed by the processor, cause the network terminal to:
obtain a first initial configuration parameter for a first network link for communicating with a user terminal;
determine a target configuration parameter for at least one target network link based at least on the first initial configuration parameter, the at least one target network link including at least a second network link for communicating with the user terminal, and the second network link having a second initial configuration parameter different from the first initial configuration parameter; and
perform configuration parameter reconfiguration for at least the second network link based on the target configuration parameter, to enable the user terminal to receive data sent by the network terminal based on aggregation of the first network link and the second network link.

13. The network terminal according to claim 1, wherein:
the instructions, when executed by the processor, further cause the network terminal to:
obtain the second initial configuration parameter; and
determine the target configuration parameter based on the first initial configuration parameter and the second initial configuration parameter; and
the first initial configuration parameter is configured with a first discontinuous reception (DRX) parameter, the second initial configuration parameter is configured with a second DRX parameter different from the DRX parameter.

14. The network terminal according to claim 13, wherein the instructions, when executed by the processor, further cause the network terminal to, when determining the target configuration parameter based on the first initial configuration parameter and the second initial configuration parameter:
obtain the first DRX parameter within the first initial configuration parameter and the second DRX parameter within the second initial configuration parameter; and
determine one of the first DRX parameter and the second DRX parameter with a longer sleep time as the target configuration parameter.

15. The network terminal according to claim 13, wherein the instructions, when executed by the processor, further cause the network terminal to, when determining the target configuration parameter based on the first initial configuration parameter and the second initial configuration parameter:
obtain the first DRX parameter within the first initial configuration parameter and the second DRX parameter within the second initial configuration parameter; and
determine the target configuration parameter based on the first DRX parameter, the second DRX parameter, and weights corresponding to the first DRX parameter and the second DRX parameter, respectively.

16. The network terminal according to claim 13, wherein the instructions, when executed by the processor, further cause the network terminal to, when determining the target configuration parameter based on the first initial configuration parameter and the second initial configuration parameter:
obtain the first DRX parameter within the first initial configuration parameter and the second DRX parameter within the second initial configuration parameter; and
determine one of the first DRX parameter and the second DRX parameter with a higher priority as the target configuration parameter.

17. A data transmission method comprising:
receiving a target configuration parameter for at least one target network link allocated by a network terminal, the target configuration parameter being determined based on a first initial configuration parameter for a first network link, the at least one target network link including at least a second network link, and the second network link having a second initial configuration parameter different from the first initial configuration parameter;
reconfiguring at least the second network link based on the target configuration parameter; and
receiving data sent by the network terminal based on aggregation of the first network link and the second network link.

18. The method according to claim 17, wherein:
the target configuration parameter is determined based on the first initial configuration parameter and the second initial configuration parameter obtained through the network terminal;
the first initial configuration parameter is configured with a first discontinuous reception (DRX) parameter; and
the second initial configuration parameter is configured with a second DRX parameter different from the first DRX parameter.

19. A user terminal comprising:
a processor; and
a memory storing instructions that, when executed by the processor, cause the user terminal to perform the method according to claim 17.

20. A non-transitory machine-readable storage medium storing instructions that, when executed by a processor, cause a user terminal including the processor to perform the method according to claim 17.
